(19) United States
(12) Patent Application Publication
(10) Pub. No.: US 2011/0163906 A1
(43) Pub. Date: Jul. 7, 2011

(54) RADAR APPARATUS, ANTENNA APPARATUS, AND DATA ACQUISITION METHOD

(75) Inventors: Joo Yeol YANG, Hwanseong-si (KR); Jae Eun Lee, Hwaseong-si (KR); Kyeong Jin Song, Suwon-si (KR); Seong Hee Jeong, Seoul (KR); Seung Un Choi, Seoul (KR); Hyung Suk Ham, Daejeon (KR)

(73) Assignee: MANDO CORPORATION

(21) Appl. No.: 12/984,325

(22) Filed: Jan. 4, 2011

(30) Foreign Application Priority Data
Jan. 5, 2010 (KR) 10-2010-0000338

(51) Int. Cl. G01S 13/04; G01S 13/00

(52) U.S. Cl. 342/27; 342/93; 342/147; 342/195

(57) ABSTRACT

A radar apparatus, an antenna apparatus, and a data acquisition method are provided, which can reduce the size of a radar apparatus as well as maintaining angular resolution.

### CROSS-REFERENCE TO RELATED APPLICATION

This application claims priority from and the benefit under 35 U.S.C. §19(a) of Korean Patent Application No. 10-2010-0000338, filed on Jan. 5, 2010, which is hereby incorporated by reference for all purposes as if fully set forth herein.

### BACKGROUND OF THE INVENTION

1. Field of the Invention

The present invention relates to a radar apparatus, an antenna apparatus, and a data acquisition method, and more particularly to a technology that can reduce the size of a radar apparatus as well as maintaining angular resolution.

2. Description of the Prior Art

As generally known in the art, a radar apparatus mounted on a vehicle or the like must have high angular resolution. For example, in the case of a vehicle radar for preventing forward collision, during in-path cut in and cut out of a vehicle in a front neighboring lane, a cut in situation can be judged through an angle extraction. That is, through a high angular resolution capability, erroneous target sensing probability during cut in and cut out of a vehicle is reduced, and a driver's safety is guaranteed through prediction of a collision situation. For this, a radar apparatus in the related art has a structure in which several receiving antennas are arranged to obtain high angular resolution. That is, the radar apparatus in the related art uses a structure that heightens the angular resolution through arrangement of multiple channels of receiving antennas.

The radar apparatus in the related art that has a structure in which several receiving antennas are arranged has the problem that the whole size of the radar apparatus is increased since the size of the antenna structure is increased and many elements related to a transmission/reception unit (that is, RF circuit unit) are required.

However, at present, when mounting a radar apparatus on a vehicle, a portion on which the radar apparatus can be mounted is limited due to various kinds of structures, such as an ultrasonic sensor in a bumper, a vehicle license plate, mist lights, support structures, and the like, and thus the size of the radar apparatus should be limited.

Accordingly, development of a radar apparatus that can reduce the size of the radar apparatus as well as maintaining high angular resolution is required, but the radar apparatus in the related art cannot satisfy such requirements.

### SUMMARY OF THE INVENTION

Accordingly, the present invention has been made to solve the above-mentioned problems occurring in the prior art, and an object of the present invention is to provide an antenna structure which can reduce the size of a radar apparatus while maintaining high angular resolution and a radar apparatus design technology that can efficiently transmit/receive signals using such an antenna structure.

In accordance with one aspect of the present invention, there is provided a radar apparatus, which includes an antenna unit including a plurality of transmission antennas and a plurality of reception antennas; and a transmission/reception unit transmitting a transmission signal through one transmission antenna switched among the plurality of transmission antennas or transmitting the transmission signal through a multi-transmission channel allocated to the plurality of transmission antennas, and receiving a reception signal, which is a reflection signal that is obtained by reflecting the transmitted transmission signal on a target, through one reception antenna switched among the plurality of reception antennas or receiving the reception signal through a multi-reception channel allocated to the plurality of reception antennas.

In accordance with another aspect of the present invention, there is provided an antenna apparatus, which includes a plurality of transmission antennas and a plurality of reception antennas; wherein a distance between the plurality of transmission antennas is in proportion to a value that is obtained by multiplying a distance between the plurality of reception antennas by the number of the plurality of reception antennas.

In accordance with still another aspect of the present invention, there is provided an antenna apparatus, which includes a plurality of transmission antennas and a plurality of reception antennas; wherein the plurality of transmission antennas are classified into a plurality of transmission antenna groups that include one or more transmission antennas or classified into one or more transmission antenna groups that include two or more transmission antennas; the plurality of reception antennas are classified into a plurality of reception antenna groups that include one or more reception antennas or classified into one or more reception antenna groups that include two or more reception antennas; and the classified transmission antenna groups and the classified reception antenna groups are alternately arranged.

In accordance with still another aspect of the present invention, there is provided a data acquisition method provided by a radar apparatus, which includes the steps of (a) switching one of a plurality of transmission antennas; (b) transmitting a transmission signal through the switched transmission antenna; (c) receiving a reception signal, which is a reflection signal that is obtained by reflecting the transmitted transmission signal, through the respective reception antennas as switching the plurality of reception antennas one by one; and (d) digital-converting the reception signal received through the respective switched reception antennas and storing reception data that is the digital-converted reception signal in a buffer; wherein a series of steps including the steps (a), (b), (c), and (d) is repeatedly performed until all of the plurality of transmission antennas are switched.

As described above, according to an embodiment of the present invention, an antenna structure which can reduce the size of a radar apparatus while maintaining high angular resolution and a radar apparatus design technology that can efficiently transmit/receive signals using such an antenna structure can be provided.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the configuration of a radar apparatus according to an embodiment of the present invention;

FIGS. 2A to 2C are diagrams exemplarily illustrating an arrangement order of a plurality of transmission antennas and a plurality of reception antennas which are included in an antenna unit included in a radar apparatus according to an embodiment of the present invention;

FIG. 3 is a diagram exemplarily illustrating an arrangement order of a plurality of transmission antennas and a plurality of reception antennas which are included in an antenna unit included in a radar apparatus according to an embodiment of the present invention;

FIGS. 4A and 4B are diagrams illustrating a control structure of a plurality of transmission antennas and a plurality of reception antennas which are included in an antenna unit included in a radar apparatus according to an embodiment of the present invention;

FIG. 5 is an exemplary diagram illustrating a radar apparatus according to an embodiment of the present invention;

FIG. 6 is another exemplary diagram illustrating a radar apparatus according to an embodiment of the present invention;

FIG. 7 is a still another exemplary diagram illustrating a radar apparatus according to an embodiment of the present invention;

FIG. 8 is a further still another exemplary diagram illustrating a radar apparatus according to an embodiment of the present invention;

FIGS. 9A to 9C are diagrams illustrating the effect that a radar apparatus according to an embodiment of the present invention minimizes the hardware size and number as well as realizing high angular resolution;

FIGS. 10A and 10B are diagrams illustrating the effect that an angular resolution control unit included in a radar apparatus according to an embodiment of the present invention improves the angular resolution by applying an angle estimation algorithm;

FIG. 11 is a flowchart illustrating a date acquisition method provided by a radar apparatus according to an embodiment of the present invention; and

FIG. 12 is a flowchart illustrating a signal processing method provided by a radar apparatus according to an embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

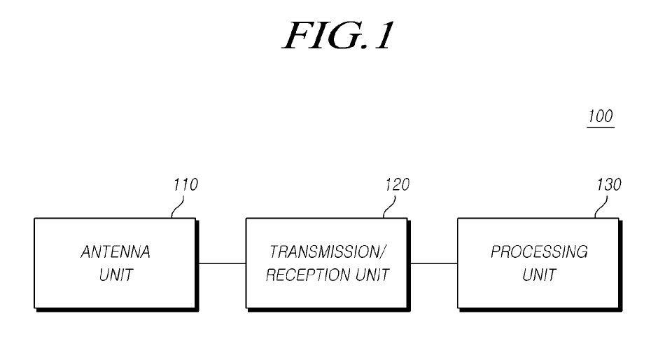

FIG. 1 is a block diagram illustrating the configuration of a radar apparatus 100 according to an embodiment of the present invention.

As illustrated in FIG. 1, a radar apparatus 100 according to an embodiment of the present invention includes an antenna unit 110 including a plurality of transmission antennas and a plurality of reception antennas, and a transmission/reception unit 120 transmitting a transmission signal and receiving a reception signal through the antenna unit 110. This radar apparatus is also called a radar sensor.

The transmission/reception unit 120 includes a transmission unit transmitting a transmission signal through a transmission antenna switched among the plurality of transmission antennas or transmitting the transmission signal through a multi-transmission channel allocated to the plurality of transmission antennas, and a reception unit receiving a reception signal, which is a reflection signal that is obtained by reflecting the transmitted transmission signal on a target, through one reception antenna switched among the plurality of reception antennas or receiving the reception signal through a multi-reception channel allocated to the plurality of reception antennas.

The transmission unit included in the transmission/reception unit 120 includes an oscillation unit generating the transmission signal for one transmission channel allocated to the switched transmission antenna or a multi-transmission channel allocated to the plurality of transmission antennas. This oscillation unit, for example, may include a VCO (Voltage-Controlled Oscillator) and an oscillator.

The reception unit included in the transmission/reception unit 120 includes an LNA (Low Noise Amplifier) low-noise-amplifying the reception signal received through one reception channel allocated to the switched reception antenna or through a multi-reception channel allocated to the plurality of reception antennas, a mixer mixing the low-noise-amplified reception signals, an amplifier amplifying the mixed reception signal, and an ADC (Analog-to-Digital Converter) digital-converting the amplified reception signal and generating reception data.

Referring to FIG. 1, the radar apparatus 100 according to an embodiment of the present invention includes a processing unit 130 performing control of the transmission signal and signal processing using the reception data. This processing unit 130 efficiently distributes signal processing that requires a large amount of computation to a first processing unit and a second processing unit, and thus the cost and the hardware size can be reduced.

The first processing unit included in the processing unit 130 is a preprocessor for the second processing unit. The first processing unit acquires the transmission data and the reception data, controls generation of the transmission signal in the oscillation unit based on the acquired transmission data, synchronizes the transmission data and the reception data, and frequency-converts the transmission data and the reception data.

The second processing unit is a postprocessor that performs an actual process using the processing result of the first processing unit. The second processing unit performs a CFAR (Constant False Alarm Rate) operation, a tracking operation, a target selection operation, and the like, based on the reception data frequency-converted by the first processing unit, and extracts angle information, speed information, and distance information.

The first processing unit performs data buffering of the acquired transmission data and the acquired reception data in a unit sample size that can be processed for one period. The first processing unit may perform the frequency conversion using a Fourier transform such as an FFT (Fast Fourier Transform).

The second processing unit may perform a failsafe function and a diagnostic function as it communicates with one or more of an engine, a peripheral sensor, a peripheral ECU (Electronic Control Unit) and various kinds of vehicle control systems (for example, ESC (Electronic Stability Control) system and the like).

The first processing unit may be implemented by FPGA (Field Programmable Gate Array, hereinafter referred to as “FPGA”) or ASIC (Application Specific Integrated Circuit, hereinafter referred to as “ASIC”), and the second processing unit may be implemented by MCU (Micro Controller Unit, hereinafter referred to as “MCU”) or DSP (Digital Signal Processor, hereinafter referred to as “DSP”). Through the above-described constituent elements, the amount of processing operation and the hardware size can be optimized.

In other words, the first processing unit controls the generation of the transmission signal (modulation signal) through control of the oscillation unit in the transmission/reception unit 120, performs synchronization between the transmission data and the reception, and performs data buffering of the reception data received through the channels of the respective reception antenna in a unit sample size that can be processed for a period. Accordingly, a separate SDRAM or SRAM is not required, and by performing windowing and frequency conversion after buffering, the first processing unit can perform parts which repeat and have a large amount of matrix operations. Accordingly, if the existing DSP is used as the first processing unit having a large amount of operations as described above, at least one SDRAM is required as a memory, and a flash ROM for booting is required, so that the peripheral circuits are complicated and the size becomes larger. However, according to the present invention, by implementing the first processing unit by a one chip of FPGA or ASIC, a large amount of operations can be processed quickly, the peripheral circuits become simplified, and the size becomes smaller. Also, in the case of implementing the first processing unit by the DSP, the booting time through the flash ROM requires several seconds, whereas in the case of implementing the first processing unit by the FPGA, real time activation within several hundreds of milliseconds becomes possible during an initial start operation or restart operation after resetting of the operation. After the first processing unit implemented by the FPGA or ASIC performs the generation of the transmission signal, transmission/reception signal synchronization, and frequency conversion operation, the second processing unit performs a peak detection and CFAR operation in a frequency domain, and performs computation-centered operation such as tracking, target selection, and the like. Since such computation-centered operation is not a matrix multiplication operation that requires a large amount of operation, an MCU having a general bit number (for example, 32 bits) can sufficiently perform the operation. Also, the MCU communicates with an engine, various kinds of vehicle control systems such as ESC (Electronic Stability Control), and peripheral sensors such as yaw and G sensors through a vehicle network system such as CAN (Controller Area Network) or Flexray. Also, the second processing unit manages the radar apparatus 100, and performs failsafe and diagnostic functions as it performs a host function of the radar apparatus 100.

On the other hand, the transmission/reception unit 120 may be implemented by a discrete IC or one chip using one of GaAs (Gallium Arsenide), SiGe (Silicon Germanium) and CMOS (Complementary Metal-Oxide Semiconductor).

The antenna unit 110 included in the radar apparatus 100 according to an embodiment of the present invention may have various types of antenna arrangement structure in accordance with the arrangement order and the arrangement distance of a plurality of transmission antennas and a plurality of reception antennas.

First, the antenna unit 110 included in the radar apparatus 100 according to an embodiment of the present invention, which has an antenna arrangement structure according to the arrangement order of a plurality of transmission antennas and a plurality of reception antennas, will be described.

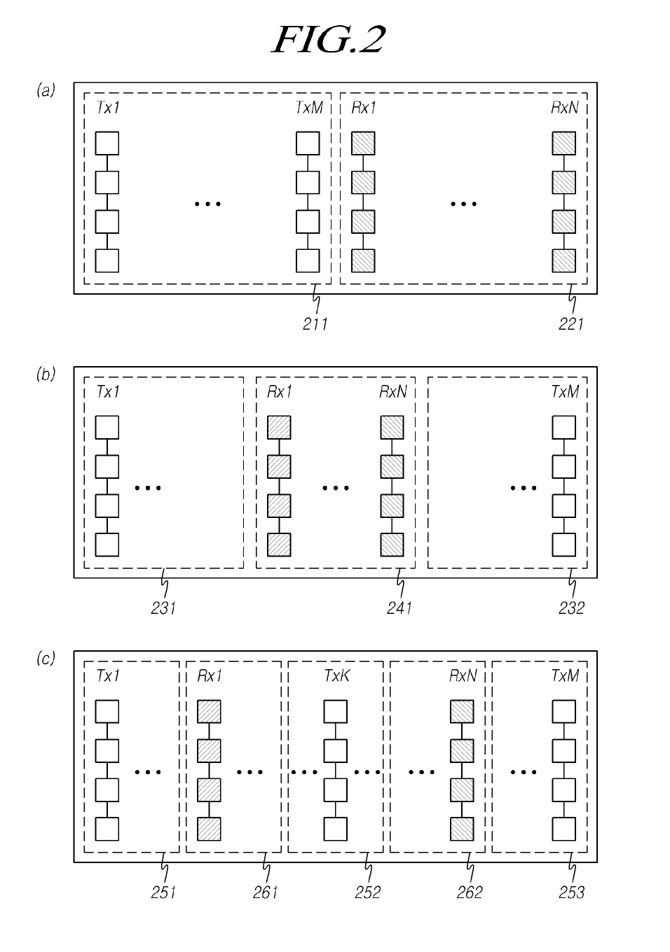

In the antenna unit 110 that includes a plurality of transmission antennas and a plurality of reception antennas, the plurality of transmission antennas are classified into a plurality of transmission antenna groups that include one or more transmission antennas or classified into one or more transmission antenna groups that include two or more transmission antennas, the plurality of reception antennas are classified into a plurality of reception antenna groups that include one or more reception antennas or classified into one or more reception antenna groups that include two or more reception antennas, and the classified transmission antenna groups and the classified reception antenna groups are alternately arranged. The antenna arrangement structure according to this arrangement order will be described in more detail with reference to three examples illustrated in FIGS. 2A to 2C.

FIG. 2A shows an antenna arrangement structure in which M transmission antennas Tx1 to TxM are classified into one transmission antenna group 211, N reception antennas Rx1 to RxN are classified into one reception antenna group 221, and one reception antenna group 221 is arranged to follow the one transmission antenna group 211. This antenna arrangement structure is called a “transmission antenna reception antenna double separation structure”.

FIG. 2B shows an antenna arrangement structure in which M transmission antennas Tx1 to TxM are classified into two transmission antenna groups 231 and 232, N reception antennas Rx1 to RxN are classified into one reception antenna group 241, and the antenna groups are arranged in the order of the first transmission antenna group 231, the reception antenna group 241, and the second transmission antenna group 232. This antenna arrangement structure is called a “transmission antenna including reception antenna structure”.

FIG. 2C shows an antenna arrangement structure in which M transmission antennas Tx1 to TxM are classified into three transmission antenna groups 251, 252, and 253, N reception antennas Rx1 to RxN are classified into two reception antenna groups 261 and 262, and the antenna groups are arranged in the order of the first transmission antenna group 251, the first reception antenna group 261, the second transmission antenna group 252, the second reception antenna group 262, and the third transmission antenna group 253. This antenna arrangement structure is called a “transmission antenna reception antenna multi-separation structure”.

Next, the antenna arrangement structure according to the arrangement distance of a plurality of transmission antennas and a plurality of reception antennas which are included in the antenna unit included in the radar apparatus 100 according to an embodiment of the present invention will be described.

According to an embodiment of the present invention, the distance between the transmission antennas may be set to be in proportion to a value that is obtained by multiplying the distance between the reception antennas by the number of the plurality of reception antennas. That is, if it is assumed that the distance between the plurality of reception antennas is d and the number of the plurality of reception antennas is N, the distance between the plurality of transmission antennas may be a value that is in proportion to N*d.

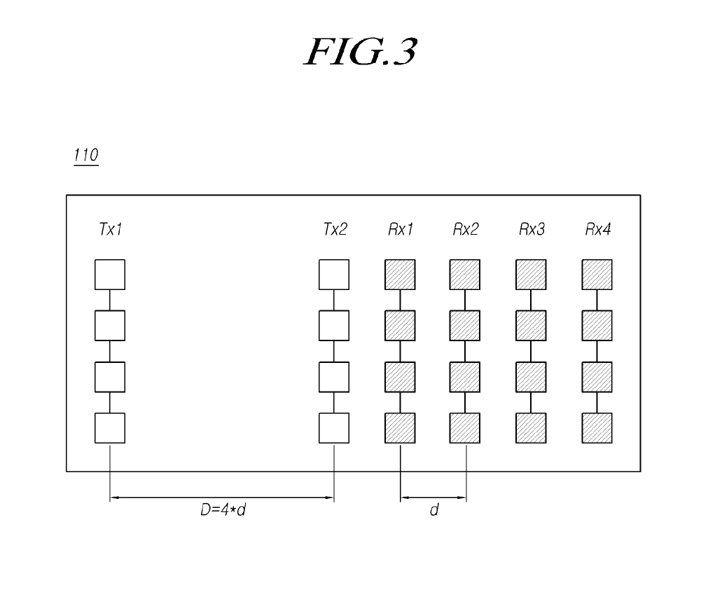

The antenna arrangement structure according to the arrangement distance will be described with reference to FIG. 3. In FIG. 3, it is assumed that the antenna unit 110 includes two transmission antennas Tx1 and Tx2 and four reception antennas Rx1, Rx2, Rx3, and Rx4. In this case, since the distance between the four reception antennas Rx1, Rx2, Rx3, and Rx4 is d and the number of reception antennas is 4, the distance D between the two transmission antennas Tx1 and Tx2 may be 4*d.

On the other hand, a value that is obtained by multiplying the number of the plurality of transmission antennas by the number of the plurality of reception antennas, which are included in the antenna unit 110, is a value that is determined to be in inverse proportion to the angular resolution required by the radar apparatus 110. The angular resolution as described above may also be called a lateral resolution.

Also, in order to obtain an angular resolution that has a higher performance than that of the physical angular resolution of the antenna unit 110 in the radar apparatus 100 according to an embodiment of the present invention, the radar apparatus 100 may further include an angular resolution control unit that controls the angular resolution so that the angular resolution can be improved through an angle estimation algorithm such as normalized LMS, RLS, MUSIC, ESPRIT, or the like. By this angular resolution control unit, the position angle of a target that can be discriminated becomes more accurate.

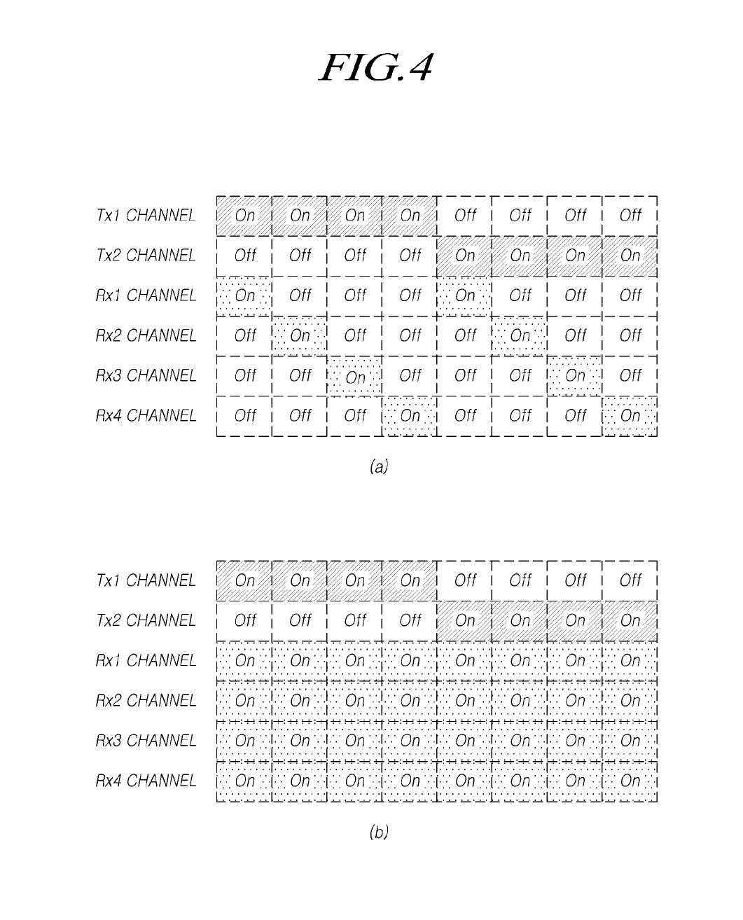

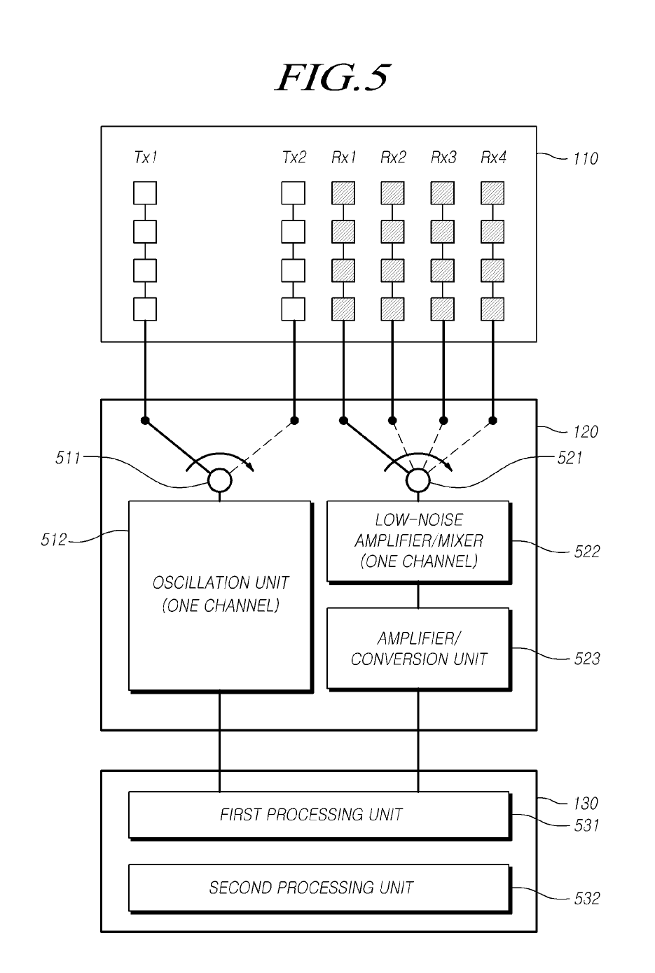

Hereinafter, the antenna control for the radar apparatus 100 according to an embodiment of the present invention will be described with reference to FIGS. 4A and 4B, and four implementation examples of the radar apparatus 100 in relation to this will be described with reference to FIGS. 5 to 8. In the following description, it is assumed that as illustrated in FIG. 3, the antenna unit 110 includes two transmission antennas Tx1 and Tx2 and four reception antennas Rx1, Rx2, Rx3, and Rx4, and the distance D between the two transmission antennas Tx1 and Tx2 is a value that is obtained by multiplying the distance d between the reception antennas by the number (four) of the reception antennas.

FIGS. 4A and 4B are diagrams illustrating a control structure of two transmission antennas Tx1 and Tx2 and four reception antennas Rx1, Rx2, Rx3, and Rx4 which are included in the antenna unit 100 included in the radar apparatus according to an embodiment of the present invention.

The radar apparatus 100 according to an embodiment of the present invention turns on the channel of the first transmission antenna Tx1, radiates a transmission signal through the first transmission antenna Tx1, and receives a reflection signal, which is obtained as the radiated transmission signal is reflected by another object (target), as a reception signal through four channels of the four reception antennas Rx1, Rx2, Rx3, and Rx4 to acquire reception data. Then, the radar apparatus 100 turns on the channel of the second transmission antenna Tx2, radiates a transmission signal through the first transmission antenna Tx1, and receives a reflection signal, which is obtained as the radiated transmission signal is reflected by the object (target), as a reception signal through the four channels of the four reception antennas Rx1, Rx2, Rx3, and Rx4 to acquire reception data.

In transmitting the transmission signal and receiving the reception signal in the above-described manner, as illustrated in FIGS. 4A and 4B, it is assumed that the transmission signal generated by the oscillation unit of the transmission/reception unit 120 is transmitted as the two transmission antennas Tx1 and Tx2 are sequentially switched. Also, in receiving the reception signal, in accordance with the control method of the reception antennas, the four reception antennas Rx1, Rx2, Rx3, and Rx4 may receive the reception signal in the same switching method as the transmission antennas as illustrated in FIG. 4A or may receive the reception signal in the multi-channel method as illustrated in FIG. 4B.

First, in the case where the antenna control method is a switching method, with reference to FIG. 4A, the oscillation unit (voltage controlled oscillator and oscillator) generates a transmission signal that is a modulation signal having a waveform, and in order to transmit the transmission signal, the first transmission antenna Tx1 and the second transmission antenna Tx2 are sequentially switched. That is, the first transmission antenna Tx1 is first switched to transmit the transmission signal therethrough, the transmission signal is reflected by the target, and the reflection signal is received through the four reception antennas Rx1, Rx2, Rx3, and Rx4 as the reception signal. Also, the four reception antennas Rx1, Rx2, Rx3, and Rx4 are sequentially switched at intervals by channels in the same manner as the switching method of the transmission antennas to receive the reception signal. When the first transmission antenna Tx1 is first switched and the channel of the first transmission antenna Tx1 is turned on to transmit the transmission signal, the corresponding channels are turned on in the order of the first reception antenna Rx1, the second reception antenna Rx2, the third reception antenna Rx3, and the fourth reception antenna Rx4 to receive the reception signal. Thereafter, the second transmission antenna Tx2 is switched, and the channel of the second transmission antenna Tx2 is turned on to transmit the transmission signal. Accordingly, the corresponding channels are turned on in the order of the first reception antenna Rx1, the second reception antenna Rx2, the third reception antenna Rx3, and the fourth reception antenna Rx4 to receive the reception signal again.

In the existing radar apparatus, since the oscillation unit VCO, the low-noise amplifier LNA, and the mixer MIXER, which are included in the transmission/reception unit 120 by antenna channels, are individually designed, the oscillation unit requires two channels for the two transmission antennas Tx1 and Tx2, and the low-noise amplifier LNA, the mixer MIXER, the converter ADC, and the amplifier require four channels for the four reception antennas Rx1, Rx2, Rx3, and Rx4.

By contrast, in the case where the radar apparatus 100 according to an embodiment of the present invention performs the antenna control according to the switching method, the oscillation unit, which requires two channels in the related art, requires only one channel. Also, the low-noise amplifier LNA, the mixer MIXER, the converter ADC, and the amplifier, which require four channels in the related art, require only one channel.

On the other hand, the antenna structure (antenna structure of 2Tx+4Rx) using two transmission antennas Tx1 and Tx2 and four reception antennas Rx1, Rx2, Rx3, and Rx4 included in the antenna unit 110 according to an embodiment of the present invention and the antenna structure of 1Tx+8Rx (one transmission antenna and 8 reception antennas) that is the antenna structure in the related art having the same angular resolution (which is in inverse proportion to a value obtained by multiplying the number of transmission antennas by the number of reception antennas) are compared with each other. According to the antenna structure (antenna structure of 1Tx+8Rx) in the related art, the RF elements, such as the low-noise amplifier LNA, the mixer, the converter ADC, and the amplifier, which are connected to the reception terminal of the reception antenna, require 8 channels. However, according to the antenna structure (antenna structure of 2Tx+4Rx) according to the present invention, a switch is used, and the RF elements, such as the low-noise amplifier LNA, the mixer, the converter ADC, and the amplifier, which are connected to the reception terminal of the reception antenna, require only one channel rather than 8 channels in realizing the same high angular resolution as that in the related art. Because of this, the size of the apparatus can be greatly reduced with considerable cost reduction effect.

On the other hand, as the antenna control method, a multi-channel method rather than the above-described switching method may be used. In the case of using the multi-channel method as the antenna control method of the transmission antennas, the respective transmission antennas are connected to the transmission/reception unit 120 through individual transmission ports, and individual transmission channels are allocated to the respective transmission antennas and corresponding transmission ports. Accordingly, the reception signal can be received using the multi-reception channel that includes individual reception channels the number of which is equal to the number of reception antennas. If the antenna control is performed in this multi-channel method, the reception signal received in the antenna unit 110 is directly transferred to the transmission/reception unit 120 or the transmission signal generated by the transmission/reception unit 110 is directly transferred to the antenna unit 110, and thus very exquisite real-time signal process becomes possible without delay due to the switching in the switching method.

The case where the reception signal is received by performing the antenna control in the multi-channel method can be conformed through FIG. 4B. Once the first transmission antenna Tx1 is switched to transmit the transmission signal, the reception signal, which is the reflection signal reflected from the target, can be received through the corresponding channels of the four reception antennas Rx1, Rx2, Rx3, and Rx4. Next, if the second transmission antenna Tx2 is switched and the transmission signal is transmitted through the second transmission antenna Tx2, the reception signal, which is the reflection signal reflected from the target, can be received through the corresponding channels of the four reception antennas Rx1, Rx2, Rx3, and Rx4.

Both the transmission unit and the reception unit included in the transmission/reception unit 120 may receive the transmission signal and the reception signal by performing the antenna control in the switching method, both the transmission unit and the reception unit included in the transmission/reception unit 120 may receive the transmission signal and the reception signal by performing the antenna control in the multi-channel method, or one of the transmission unit and the reception unit included in the transmission/reception unit 120 may transmit the transmission signal and receive the reception signal using the switching method and the other may transmit the transmission signal and receive the reception signal using the multi-channel method.

FIG. 5 is a diagram exemplarily illustrating the radar apparatus 100 according to an embodiment of the present invention in the case where both the transmission unit and the reception unit included in the transmission/reception unit 120 receive the transmission signal and the reception signal by performing the antenna control in the switching method.

Referring to FIG. 5, the transmission unit included in the transmission/reception unit 120, under the control of the first processing unit 531, transmits the transmission signal generated by the oscillation unit 512 through the switched transmission antenna while alternately switching the two transmission antennas Tx1 and Tx2 using a transmission-side switch 511. In this case, the oscillation unit 512 requires only one transmission channel.

Also, referring to FIG. 5, the reception unit included in the transmission/reception unit 120 receives the reception signal while alternately switching the four reception antennas Rx1, Rx2, Rx3, and Rx4 using a reception-side switch 521. The reception signal received as described above passes through the low-noise amplifier/mixer 522 and an amplifier/converter 523, and then is processed by the first processing unit 531 and the second processing unit 532. In this case, the low-noise amplifier/mixer 522 requires only one reception channel.

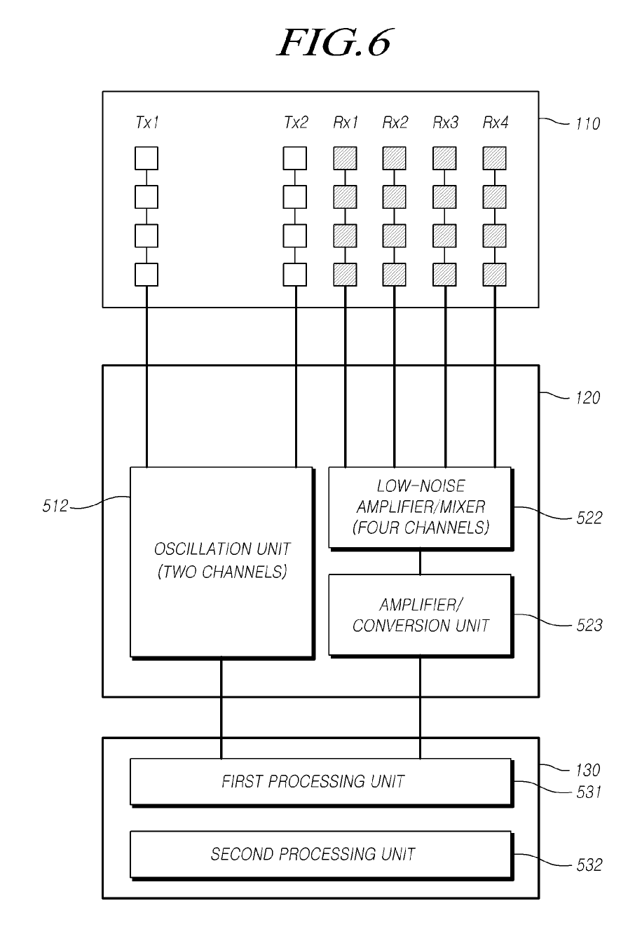

FIG. 6 is a diagram exemplarily illustrating the radar apparatus 100 according to an embodiment of the present invention in the case where both the transmission unit and the reception unit included in the transmission/reception unit 120 receive the transmission signal and the reception signal by performing the antenna control in the multi-channel method.

Referring to FIG. 6, the transmission unit included in the transmission/reception unit 120, under the control of the first processing unit 531, transmits the transmission signal generated by the oscillation unit 512 through a multi-transmission channel (including two individual transmission channels Tx CH1 and Tx CH2) that are allocated to the two transmission antennas Tx1 and Tx2 rather than using the transmission-side switch 511. In this case, the oscillation unit 512 requires two individual transmission channels Tx CH1 and Tx CH2 included in the multi-transmission channel.

Also, referring to FIG. 6, the reception unit included in the transmission/reception unit 120 receives the reception signal through the multi-reception channel (including four individual reception channels Rx CH1, Rx CH2, Rx CH3, and Rx CH4) that is allocated to the four reception antenna Rx1, Rx2, Rx3, and Rx4 rather than using the reception-side switch 521 as illustrated in FIG. 5. The reception signal received as described above passes through the low-noise amplifier/mixer 522 and an amplifier/converter 523, and then is processed by the first processing unit 531 and the second processing unit 532. In this case, the low-noise amplifier/mixer 522 requires four individual reception channels Rx CH1, Rx CH2, Rx CH3, and Rx CH4 included in the multi-reception channel.

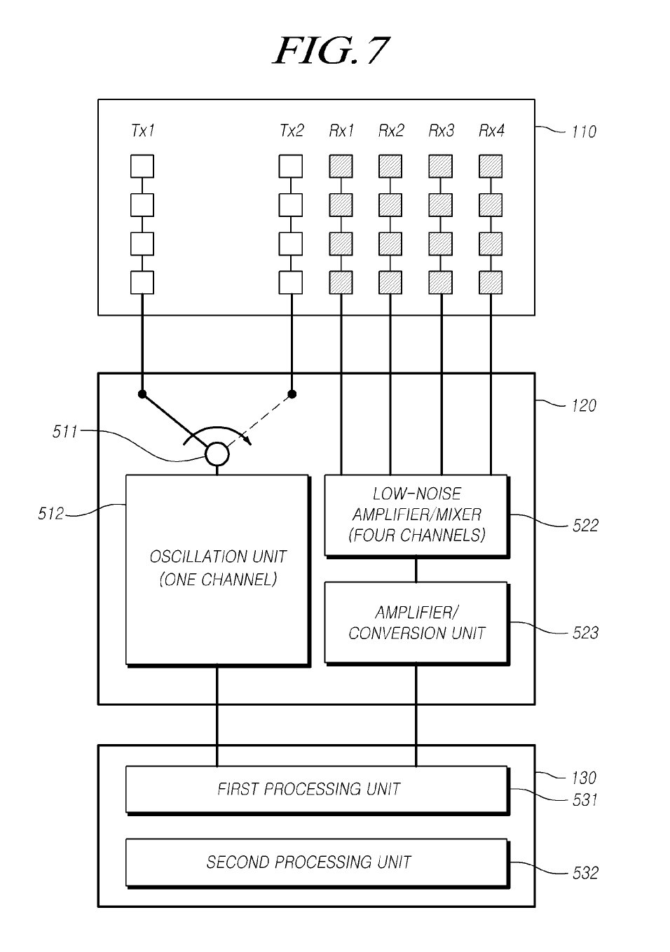

FIG. 7 is a diagram exemplarily illustrating the radar apparatus 100 according to an embodiment of the present invention in the case where the transmission unit transmits the transmission signal in the switching method and the reception unit receives the reception signal in the multi-channel method.

Referring to FIG. 7, the transmission unit included in the transmission/reception unit 120, under the control of the first processing unit 531, transmits the transmission signal generated by the oscillation unit 512 while alternately switching the two transmission antennas Tx1 and Tx2 using a transmission-side switch 511 as illustrated in FIG. 5. In this case, the oscillation unit 512 requires only one transmission channel.

Also, referring to FIG. 7, the reception unit included in the transmission/reception unit 120 receives the reception signal through the multi-reception channel (including four individual reception channels Rx CH1, Rx CH2, Rx CH3, and Rx CH4) that is allocated to the four reception antennas Rx1, Rx2, Rx3, and Rx4 rather than using the reception-side switch 521 as illustrated in FIG. 5. The reception signal received as described above passes through the low-noise amplifier/mixer 522 and an amplifier/converter 523, and then is processed by the first processing unit 531 and the second processing unit 532. In this case, the low-noise amplifier/mixer 522 requires four individual reception channels Rx CH1, Rx CH2, Rx CH3, and Rx CH4 included in the multi-reception channel.

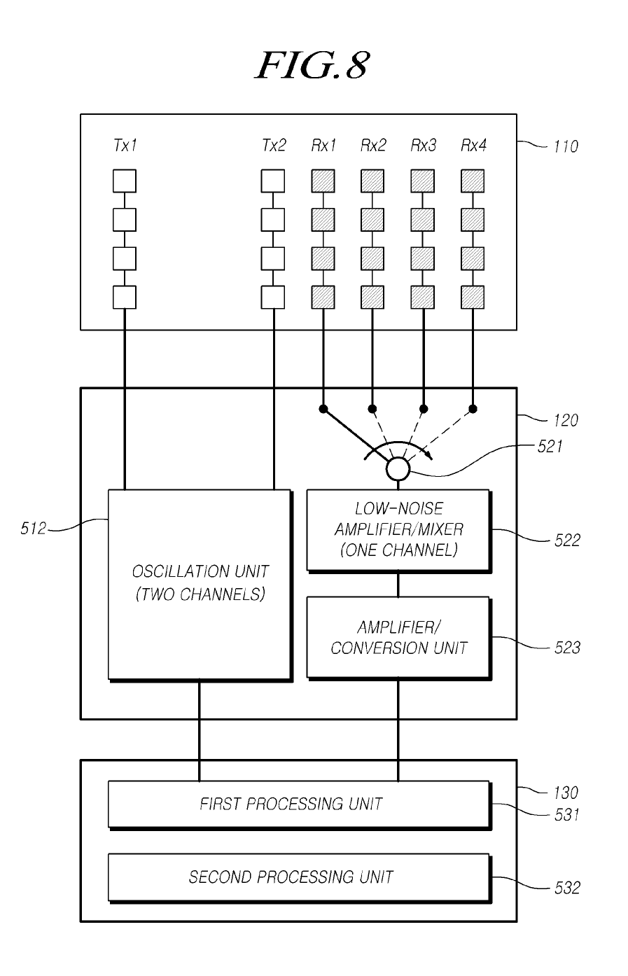

FIG. 8 is a diagram exemplarily illustrating the radar apparatus 100 according to an embodiment of the present invention in the case where the transmission unit transmits the transmission signal in the multi-channel method and the reception unit receives the reception signal in the switching method.

Referring to FIG. 8, the transmission unit included in the transmission/reception unit 120, under the control of the first processing unit 531, transmits the transmission signal generated by the oscillation unit 512 through the multi-transmission channel (including two individual transmission channels Tx CH1 and Tx CH2) allocated to the two transmission antenna Tx1 and Tx2 rather than using the transmission-side switch 511 as illustrated in FIG. 5. In this case, the oscillation unit 512 requires two individual transmission channels Tx CH1 and Tx CH2 included in the multi-transmission channel.

Also, referring to FIG. 8, the reception unit included in the transmission/reception unit 120 receives the reception signal while alternately switching the four reception antennas Rx1, Rx2, Rx3, and Rx4 using the reception-side switch 521 as illustrated in FIG. 5. The reception signal received as described above passes through the low-noise amplifier/mixer 522 and an amplifier/converter 523, and then is processed by the first processing unit 531 and the second processing unit 532. In this case, the low-noise amplifier/mixer 522 requires only one reception channel.

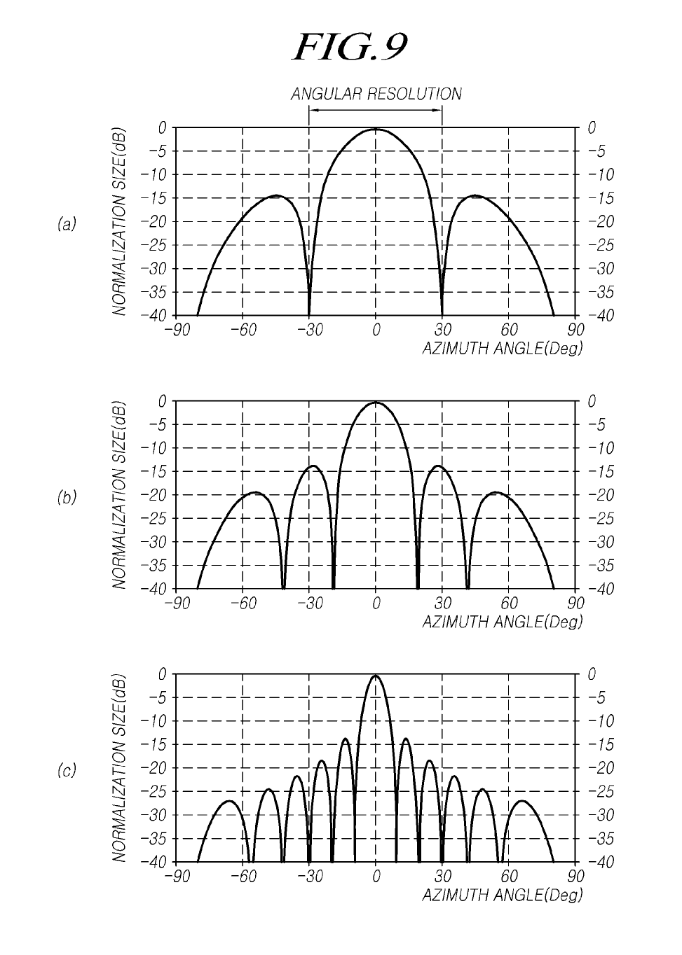

FIGS. 9A to 9C are diagrams illustrating the effect that a radar apparatus 100 according to an embodiment of the present invention minimizes the hardware size and number as well as realizing high angular resolution.

The angular resolution in the radar apparatus 100 is in inverse proportion to a value obtained by multiplying the number M of transmission antennas by the number N of reception antennas. The angular resolution may be expressed as in Equation (1). In Equation (1), d represents a distance between reception antennas.

$$Angular Resolution ∝ \frac{1}{M \times N \times d} \qquad ( 1 )$$

According to the above described contents, in order to make the angular resolution have high performance, FOV (Field Of View) is narrowed through increase of the number of reception antennas and through this, the angular resolution can be heightened. In consideration of this point, the angular resolution in the case where the number of transmission antennas is M and the number of reception antennas is N in the radar apparatus 100 having the multi-antenna arrangement structure according to the present invention is equal to the angular resolution in the multi-antenna arrangement structure in the case where the number of transmission antennas is 1 and the number of reception antennas is M*N in the radar apparatus in the related art. This feature will be described with reference to three cases as illustrated in FIGS. 9A to 9C. However, it is assumed that the respective transmission antennas and the respective reception antennas are allocated with the transmission channels and the reception channels. That is, it is assumed that the number of transmission antennas is equal to the number of transmission channels and the number of reception antennas is equal to the number of reception channels.

FIG. 9A is a graph illustrating beam patterns that can confirm the angular resolution in the case where the radar apparatus 100 according to the present invention has two transmission antennas and two reception antennas and the angular resolution in the case where the radar apparatus in the related art has one transmission antenna and four reception antennas. The angular resolutions are the same. However, since the total number of antennas and channels is (=2+2) in the radar apparatus according to the present invention, and is 5 (=1+4) in the radar apparatus in the related art, the radar apparatus 100 according to an embodiment of the present invention requires a smaller number of antennas and channels in comparison to the radar apparatus in the related art. Accordingly, the number of elements provided in the transmission/reception unit 120 and the processing unit 130 can be reduced in addition to the reduction of the number of antennas, and thus the size of the apparatus and the cost can be greatly reduced.

FIG. 9B is a graph illustrating beam patterns that can confirm the angular resolution in the case where the radar apparatus 100 according to the present invention has two transmission antennas and three reception antennas and the angular resolution in the case where the radar apparatus in the related art has one transmission antenna and six reception antennas. The angular resolutions are the same. However, since the total number of antennas and channels is 5 (=2+3) in the radar apparatus according to the present invention, and is 7 (=1+6) in the radar apparatus in the related art, in the same manner as in FIG. 9A, the radar apparatus 100 according to an embodiment of the present invention requires a smaller number of antennas and channels in comparison to the radar apparatus in the related art. Accordingly, the number of elements provided in the transmission/reception unit 120 and the processing unit 130 can be reduced in addition to the reduction of the number of antennas, and thus the size of the apparatus and the cost can be greatly reduced.

FIG. 9C is a graph illustrating beam patterns that can confirm the angular resolution in the case where the radar apparatus 100 according to the present invention has two transmission antennas and six reception antennas and the angular resolution in the case where the radar apparatus in the related art has one transmission antenna and twelve reception antennas. The angular resolutions are the same. However, since the total number of antennas and channels is 8 (=2+6) in the radar apparatus according to the present invention, and is 13 (=1+12) in the radar apparatus in the related art, in the same manner as in FIGS. 9A and 9B, the radar apparatus 100 according to an embodiment of the present invention requires a smaller number of antennas and channels in comparison to the radar apparatus in the related art. Accordingly, the number of elements provided in the transmission/reception unit 120 and the processing unit 130 can be reduced in addition to the reduction of the number of antennas, and thus the size of the apparatus and the cost can be greatly reduced.

As described above, the radar apparatus 100 according to an embodiment of the present invention, which shows the same performance of angular resolution as that in the radar apparatus 100 in the related art, has the effects that the number of antennas and channels is reduced according to the antenna structure and the antenna control method, the number of elements provided in the transmission/reception unit 120 and the processing unit 130 is reduced, and thus the size of the apparatus and the cost can be greatly reduced.

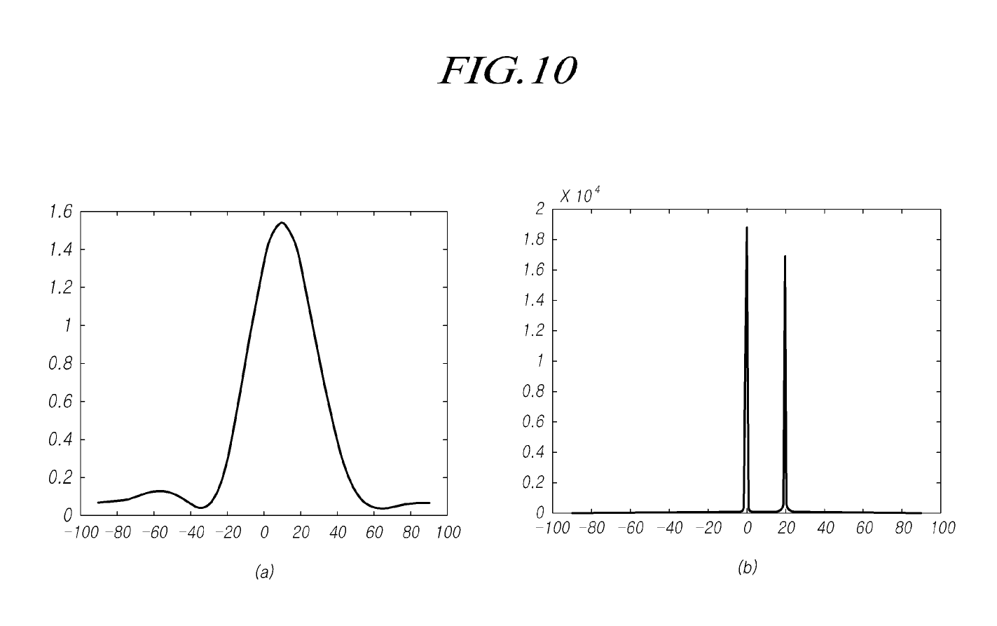

On the other hand, the radar apparatus 100 according to an embodiment of the present invention can improve the performance of the angular resolution of physical antennas by applying an angle estimation algorithm such as LMS, RLS, MUSIC, ESPRIT, and the like. Referring to FIG. 10A, in the case where targets are positioned in directions of 10 degrees and 20 degrees, respectively, the radar apparatus in the related art cannot discriminate the targets due to the angular resolution caused by the physical antenna arrangement. However, by applying the angle estimation algorithm according to the present invention, the angular resolution is heightened as illustrated in FIG. 10B to overcome the physical limit, and thus the target discrimination becomes possible.

On the other hand, a data acquisition method that is provided by the radar apparatus 100 according to an embodiment of the present invention will be described hereinafter.

The data acquisition method provided by the radar apparatus 100 according to an embodiment of the present invention includes a transmission antenna switching step of switching one of a plurality of transmission antennas; a transmission signal transmitting step of transmitting a transmission signal through the switched transmission antenna; a reception signal receiving step of receiving a reception signal, which is a reflection signal that is obtained by reflecting the transmitted transmission signal, through the respective reception antennas as switching the plurality of reception antennas one by one; and a reception data acquiring/storing step of digital-converting the reception signal received through the respective switched reception antennas and storing reception data that is the digital-converted reception signal in a buffer; wherein a series of steps including the transmission antenna switching step, the transmission signal transmitting step, the reception signal receiving step, and the reception data acquiring/storing step is repeatedly performed until all of the plurality of transmission antennas are switched.

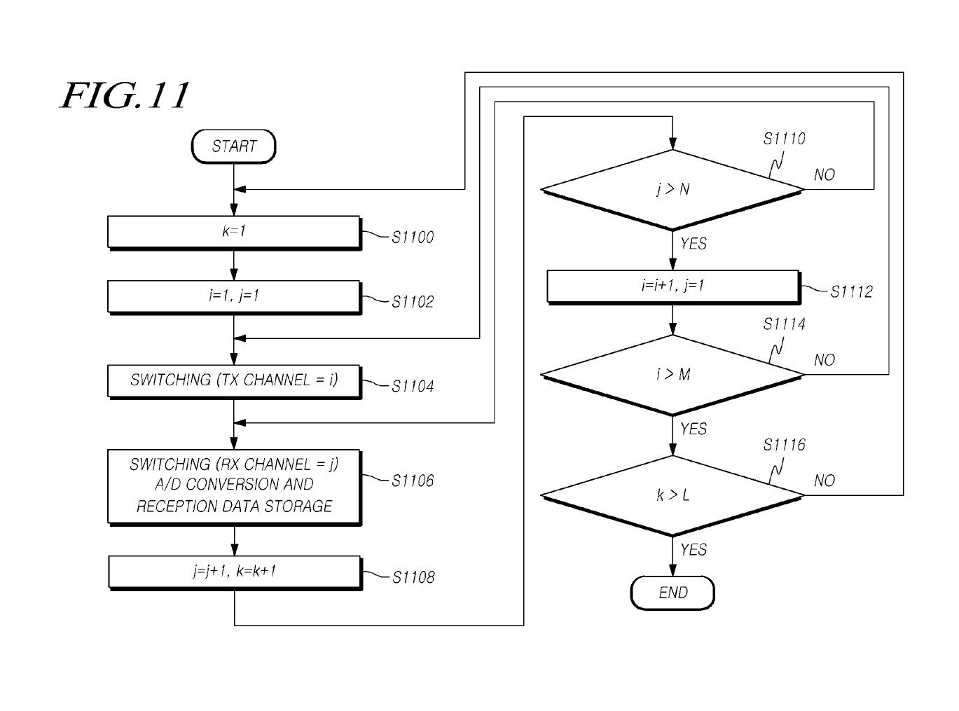

The above-described data acquisition method will be described in more detail with reference to a softwired flowchart as exemplified in FIG. 11.

Referring to FIG. 11, initial values of variables k, i, and j required for data acquisition are set (S1100 and S1102). Here, i represents identification information on channels (or number) of transmission antennas, j represents identification information on channels (or number) of reception antennas, and k represents identification information that means the number of times a reception antenna receives a reception signal. Thereafter, a transmission signal is transmitted through switching one of M transmission antennas (S1104). In order to receive a reception signal, which is a reflection signal when the transmission signal is reflected by a target, one of N reception antennas is switched to receive the reception signal, and the received reception signal is digital-converted to obtain reception data, which is stored in a buffer (S1106). Thereafter, j, which is the identification information on the channels (or the number) of the reception antennas is increased by 1 (S1108), and the steps S1106, S1108, and S1110 are repeatedly performed until it is determined that the increased j value becomes larger than N, which is the number of reception antennas (S1110).

If the j value becomes larger than N, which is the number of reception antennas as the steps S1106, S1108, and S1110 are repeatedly performed, this means that the reception signal has been received through all the N reception antennas. In this case, the i value, which is the identification information on the channels (or the number) of transmission antennas, is increased by 1 (S1112), the transmission signal is transmitted again by switching again one of the remaining transmission antennas among M transmission antennas (S1104), and in the same manner as the foregoing process, the steps S1106, S1108, and S1110 are repeatedly performed as the N reception antennas are switched until it is determined that the j value becomes larger than N, which is the number of reception antennas.

The above-described processes are repeated until it is determined that the i value, which is the identification information on the channels (or the number) of the transmission antennas, becomes larger than the number M of reception antennas (S1114).

If k, which is the identification information that means the number of times the reception antenna receives the reception signal, becomes larger than L, which is the number of times the whole reception signals are received, after all the M transmission antennas transmit the transmission signal in the above-described processes, the whole process is ended, and the reception data which is accumulatively stored in the buffer is acquired as data to be finally acquired.

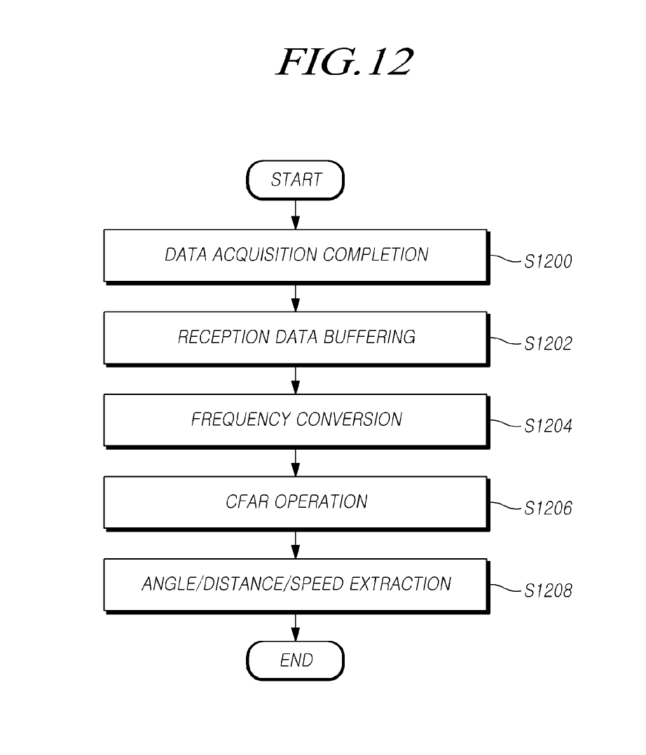

FIG. 12 is a flowchart illustrating a signal processing method provided by a radar apparatus according to an embodiment of the present invention.
FIG. 12 shows a signal processing procedure after the data acquisition (S1200) is completed according to the data acquisition method of FIG. 11. After data buffering of the reception data acquired in step S1200 is performed in a unit sample size that can be processed for one period (S1202), the frequency conversion is performed (S1204). Thereafter, a CFAR (Constant f\False Alarm Rate) operation is performed based on the frequency-converted reception data (S1206), and the angle information, speed information, and distance information of the target are extracted (S1208). The frequency conversion in step S1206 may be a Fourier transform such as an FFT (Fast Fourier Transform).

As described above, by using the radar apparatus 100 according to an embodiment of the present invention, the number of transmission antennas and reception antennas can be reduced, the corresponding elements in hardware can be reduced, and the number of elements that are required in hardware can be minimized using a switch for antenna control. Also, operations that require a large amount of computation can be promptly processed with minimum cost and size of the radar apparatus 100 using FPGA.

On the other hand, according to the present invention, an antenna apparatus is provided, which includes a plurality of transmission antennas and a plurality of reception antennas, and a distance between the plurality of transmission antennas is in proportion to a value that is obtained by multiplying a distance between the plurality of reception antennas by the number of the plurality of reception antennas.

Also, according to the present invention, an antenna apparatus is provided, which includes a plurality of transmission antennas and a plurality of reception antennas, wherein the plurality of transmission antennas are classified into a plurality of transmission antenna groups that include one or more transmission antennas or classified into one or more transmission antenna groups that include two or more transmission antennas, the plurality of reception antennas are classified into a plurality of reception antenna groups that include one or more reception antennas or classified into one or more reception antenna groups that include two or more reception antennas, and the classified transmission antenna groups and the classified reception antenna groups are alternately arranged.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A radar apparatus comprising:
an antenna unit including a plurality of transmission antennas and a plurality of reception antennas; and
a transmission/reception unit transmitting a transmission signal through one transmission antenna switched among the plurality of transmission antennas or transmitting the transmission signal through a multi-transmission channel allocated to the plurality of transmission antennas, and receiving a reception signal, which is a reflection signal that is obtained by reflecting the transmitted transmission signal on a target, through one reception antenna switched among the plurality of reception antennas or receiving the reception signal through a multi-reception channel allocated to the plurality of reception antennas.

2. The radar apparatus as claimed in claim 1, wherein the transmission/reception unit comprises:
an oscillation unit generating the transmission signal for one transmission channel allocated to the switched transmission antenna or the multi-transmission channel allocated to the plurality of transmission antennas;
a low noise amplifier low-noise-amplifying the reception signal received through one reception channel allocated to the switched reception antenna or through the multi-reception channel allocated to the plurality of reception antennas;
a mixer mixing the low-noise-amplified reception signals;
an amplifier amplifying the mixed reception signal; and
a converter digital-converting the amplified reception signal and generating reception data.

3. The radar apparatus as claimed in claim 2, further comprising:
a first processing unit acquiring the transmission data and the reception data, controlling generation of the transmission signal in the oscillation unit based on the acquired transmission data, synchronizing the transmission data and the reception data, and frequency-converting the transmission data and the reception data; and
a second processing unit performing a CFAR (Constant False Alarm Rate) operation, a tracking operation, and a target selection operation based on the frequency-converted reception data, and extracting angle information, speed information, and distance information of the target.

4. The radar apparatus as claimed in claim 3, wherein the first processing unit performs data buffering of the acquired transmission data and the acquired reception data in a unit sample size that can be processed for one period, and then performs the frequency conversion.

5. The radar apparatus as claimed in claim 3, wherein the second processing unit performs a failsafe function and a diagnostic function as it communicates with one or more of an engine, a peripheral sensor, a peripheral electronic control unit and a vehicle control system.

6. The radar apparatus as claimed in claim 3, wherein the first processing unit is implemented by FPGA (Field Programmable Gate Array) or ASIC (Application Specific Integrated Circuit), and
the second processing unit is implemented by MCU (Micro Controller Unit) or DSP (Digital Signal Processor).

7. The radar apparatus as claimed in claim 1, wherein the transmission/reception unit is implemented by a discrete IC or one-chip or two-chip using one of GaAs (Gallium Arsenide), SiGe (Silicon Germanium) and CMOS (Complementary Metal-Oxide Semiconductor).

8. The radar apparatus as claimed in claim 1, wherein the plurality of transmission antennas and the plurality of reception antennas are classified into one or more transmission antenna groups including one or more transmission antennas and one or more reception antenna groups including one or more reception antennas; and
the classified transmission antenna groups and the classified reception antenna groups are alternately arranged.

9. The radar apparatus as claimed in claim 1, wherein a distance between the transmission antennas is in proportion to a value that is obtained by multiplying a distance between the reception antennas by the number of the plurality of reception antennas.

10. The radar apparatus as claimed in claim 1, wherein a value that is obtained by multiplying the number of the plurality of transmission antennas by the number of the plurality of reception antennas is a value that is determined to be in inverse proportion to the angular resolution required by the radar apparatus.

11. The radar apparatus as claimed in claim 1, further comprising an angular resolution control unit that controls the angular resolution so that the angular resolution can be improved through an angle estimation algorithm.

12. An antenna apparatus comprising:
a plurality of transmission antennas and a plurality of reception antennas;
wherein a distance between the transmission antennas is in proportion to a value that is obtained by multiplying a distance between the reception antennas by the number of the reception antennas.

13. An antenna apparatus comprising:
a plurality of transmission antennas and a plurality of reception antennas;
wherein the plurality of transmission antennas are classified into a plurality of transmission antenna groups that include one or more transmission antennas or classified into one or more transmission antenna groups that include two or more transmission antennas;
the plurality of reception antennas are classified into a plurality of reception antenna groups that include one or more reception antennas or classified into one or more reception antenna groups that include two or more reception antennas; and
the classified transmission antenna groups and the classified reception antenna groups are alternately arranged.

14. A data acquisition method provided by a radar apparatus, comprising the steps of:
(a) switching one of a plurality of transmission antennas;
(b) transmitting a transmission signal through the switched transmission antenna;
(c) receiving a reception signal, which is a reflection signal that is obtained by reflecting the transmitted transmission signal, through the respective reception antennas as switching the plurality of reception antennas one by one; and
(d) digital-converting the reception signal received through the respective switched reception antennas and storing reception data that is the digital-converted reception signal in a buffer;
wherein a series of steps including the steps (a), (b), (c), and (d) is repeatedly performed until all of the plurality of transmission antennas are switched.
